(19) United States
(12) Patent Application Publication
(10) Pub. No.: US 2020/0013395 A1
(43) Pub. Date: Jan. 9, 2020

(54) INTELLIGENT VOICE RECOGNIZING METHOD, APPARATUS, AND INTELLIGENT COMPUTING DEVICE

(71) Applicant: LG ELECTRONICS INC., Seoul (KR)

(72) Inventors: Jaewoong JEONG, Seoul (KR); Youngman KIM, Seoul (KR); Sangjun OH, Seoul (KR); Kyuho LEE, Seoul (KR); Seunghyun HWANG, Seoul (KR)

(73) Assignee: LG ELECTRONICS INC., Seoul (KR)

(21) Appl. No.: 16/577,527

(22) Filed: Sep. 20, 2019

(30) Foreign Application Priority Data
Aug. 20, 2019 (KR) 10-2019-0101773

(51) Int. Cl. G10L 15/20; G10L 21/0232; G10L 25/84; G10L 15/22; G10L 15/06

(52) U.S. Cl. CPC G10L 15/20; G10L 21/0232; G10L 2015/0635; G10L 15/22; G10L 15/063; G10L 25/84

(57) ABSTRACT

Disclosed are an intelligent voice recognizing method, a voice recognizing device, and an intelligent computing device. According to an embodiment of the present invention, a method of intelligently recognizing a voice by a voice recognizing device obtains a microphone detection signal via at least one microphone, removes noise from the microphone detection signal based on a noise removal model, recognizes a voice from the noise-removed microphone detection signal, and updates the noise removal model based on the type of the noise detected from the microphone detection signal, thereby preventing deterioration of speech recognition performance. According to the present invention, one or more of the voice recognizing device, intelligent computing device, and server may be related to artificial intelligence (AI) modules, unmanned aerial vehicles (UAVs), robots, augmented reality (AR) devices, virtual reality (VR) devices, and 5G service-related devices.

### CROSS-REFERENCE TO RELATED APPLICATION(S)

This application is based on and claims priority under 35 U.S.C. 119 to Korean Patent Application No. 10-2019-0101773, filed on Aug. 20, 2019, in the Korean Intellectual Property Office, the disclosure of which is herein incorporated by reference in its entirety.

### TECHNICAL FIELD

The present invention relates to an intelligent voice recognizing method, apparatus, and intelligent computing device, and more specifically, to an intelligent voice recognizing method, apparatus, and intelligent computing device for noise removal.

### DESCRIPTION OF RELATED ART

A voice recognizing device is a device capable of converting a user's voice into text, analyze the meaning of the message contained in the text, and output a different form of sound based on a result of the analysis.

Example voice recognizing devices include home robots in home IoT systems or artificial intelligence (AI) speakers armed with AI technology.

### SUMMARY

The present invention aims to address the foregoing issues and/or needs.

The present invention also aims to implement an intelligent voice recognizing method, apparatus, and intelligent computing device for effectively removing noise.

According to an embodiment of the present invention, an intelligent voice recognizing method of a voice comprises: recognizing device obtaining a microphone detection signal through at least one microphone; removing noise from the microphone detection signal based on a noise removal model; recognizing a voice from the noise-removed microphone detection signal, wherein removing the noise includes updating the noise removal model based on a type of noise detected from the microphone detection signal.

The noise removal model may include an adaptive filter, and updating the noise removal model may include updating a parameter of the adaptive filter.

Updating the noise removal model may include searching a database for a parameter corresponding to the detected noise type, the database storing a plurality of noise types and a plurality of parameters per noise type and updating the parameter of the adaptive filter based on the searched-for parameter.

The plurality of parameters per noise type may include the parameter of the adaptive filter in a convergence interval, during which a magnitude of the microphone detection signal converges to a particular value, of an entire time during which adaptive noise removal is performed on a microphone detection signal from which a particular type of noise has been detected.

According to an embodiment of the present invention, an intelligent voice recognizing device comprises: a communication unit; at least one microphone; and a processor obtaining a microphone detection signal through the at least one microphone, remove noise from the microphone detection signal based on a noise removal model, and recognizing a voice from the noise-removed microphone detection signal, wherein the processor updates the noise removal model based on a type of noise detected from the microphone detection signal.

The noise removal model may include an adaptive filter, and the processor updates a parameter of the adaptive filter.

The processor may search a database for a parameter corresponding to the detected noise type, the database storing a plurality of noise types and a plurality of parameters per noise type and updates the parameter of the adaptive filter based on the searched-for parameter.

The plurality of parameters per noise type may include the parameter of the adaptive filter in a convergence interval, during which a magnitude of the microphone detection signal converges to a particular value, of an entire time during which adaptive noise removal is performed on a microphone detection signal from which a particular type of noise has been detected.

According to an embodiment of the present invention, there is provided a non-transitory computer-readable medium storing a computer-executable component configured to be executed by one or more processors of a computing device, the computer-executable component comprising obtaining a microphone detection signal, removing noise from the microphone detection signal based on a noise removal model, recognizing a voice from the noise-removed microphone detection signal, and updating the noise removal model based on a type of noise detected from the microphone detection signal.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 shows a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 shows an example of a schematic block diagram in which a text-to-speech (TTS) method according to an embodiment of the present invention is implemented.

FIG. 5 shows a block diagram of an AI device that may be applied to one embodiment of the present invention.

FIG. 6 shows an exemplary block diagram of a voice recognizing apparatus according to an embodiment of the present invention.

FIG. 7 shows a schematic block diagram of a text-to-speech (TTS) device in a TTS system according to an embodiment of the present invention.

FIG. 8 shows a schematic block diagram of a TTS device in a TTS system environment according to an embodiment of the present invention.

FIG. 9 is a schematic block diagram of an AI processor capable of performing emotion classification information-based TTS according to an embodiment of the present invention.

FIG. 10 is a flowchart illustrating a voice recognizing method according to an embodiment of the present invention;

FIG. 11 is a flowchart illustrating a specific example of the updating (S130) of FIG. 10;

FIG. 12 is a view illustrating an example process of updating a noise removal model; and

FIG. 13 is a flowchart illustrating a specific example of the updating (S130) of FIG. 10.

### DETAILED DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

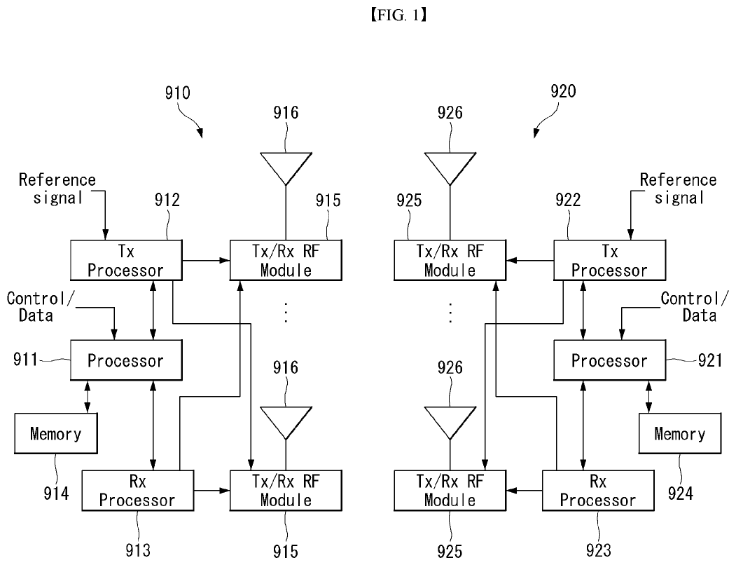

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

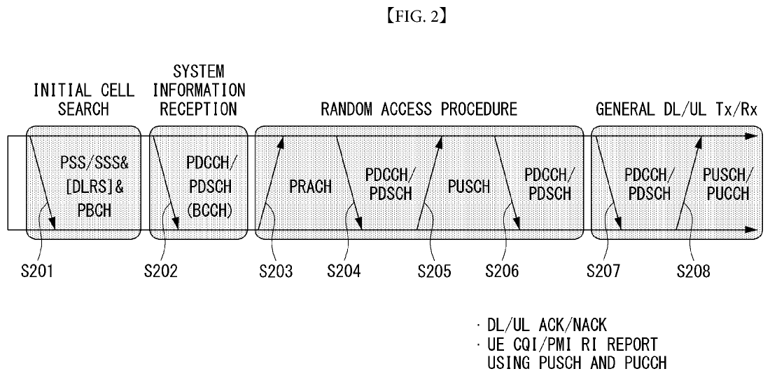

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtaind through an SSS of the cell, and information on the cell ID among 336 cell ID groups is provided/obtaind through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

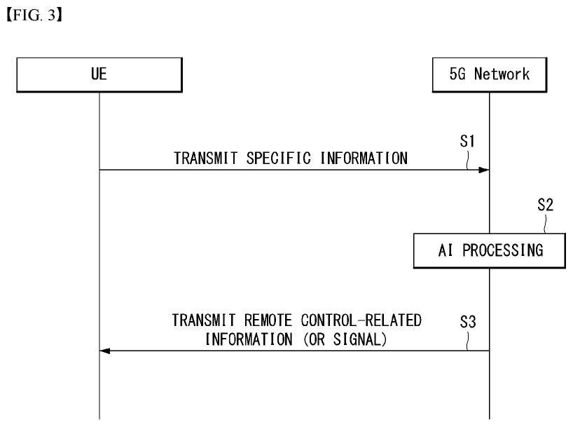

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

H. Voice Output System and AI Processing

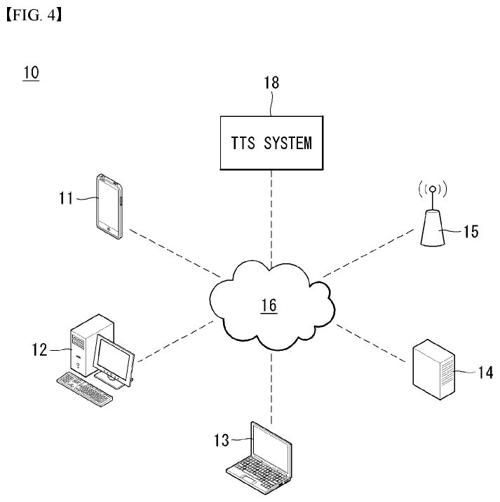

FIG. 4 illustrates a block diagram of a schematic system in which a voice output method is implemented according to an embodiment of the present invention.

Referring to FIG. 4, a system in which a voice output method is implemented according to an embodiment of the present invention may include as a voice output apparatus 10, a network system 16, and a text-to-to-speech (TTS) system as a speech synthesis engine.

The at least one voice output device 10 may include a mobile phone 11, a PC 12, a notebook computer 13, and other server devices 14. The PC 12 and notebook computer 13 may connect to at least one network system 16 via a wireless access point 15. According to an embodiment of the present invention, the voice output apparatus 10 may include an audio book and a smart speaker.

Meanwhile, the TTS system 18 may be implemented in a server included in a network, or may be implemented by on-device processing and embedded in the voice output device 10. In the exemplary embodiment of the present invention, it is assumed that the TTS system 18 is implemented in the voice output device 10.

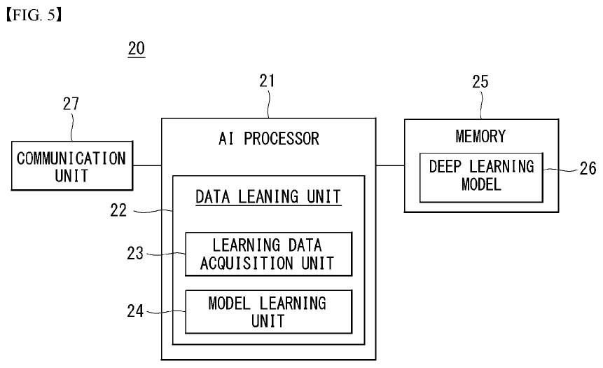

FIG. 5 shows a block diagram of an AI device that may be applied to one embodiment of the present invention.

The AI device 20 may include an electronic device including an AI module capable of performing AI processing or a server including the AI module. In addition, the AI device 20 may be included in at least a part of the voice output device 10 illustrated in FIG. 4 and may be provided to perform at least some of the AI processing together.

The above-described AI processing may include all operations related to speech recognition of the voice recognizing device 10 of FIG. 5. For example, the AI processing may be the process of analyzing microphone detection signals from the voice recognizing device 10 to thereby remove noise.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, a tablet PC, and the like.

The AI processor 21 may learn a neural network using a program stored in the memory 25.

In particular, the AI processor 21 may learn a neural network for obtaining estimated noise information by analyzing the operating state of each voice output device. In this case, the neural network for outputting estimated noise information may be designed to simulate the human's brain structure on a computer, and may include a plurality of network nodes having weight and simulating the neurons of the human's neural network.

The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice output, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by obtaining learning data to be used for learning and by applying the obtaind learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data obtaining unit 23 and a model learning unit 24.

The learning data acquisition unit 23 may obtain training data for a neural network model for classifying and recognizing data. For example, the learning data acquisition unit 23 may obtain microphone detection signal to be input to the neural network model and/or a feature value, extracted from the message, as the training data.

The model learning unit 24 can perform learning such that a neural network model has a determination reference about how to classify predetermined data, using the obtaind learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor may pre-process an obtained operating state so that the obtained operating state may be used for training for recognizing estimated noise information. For example, the learning data preprocessor may process an obtained operating state in a preset format so that the model training unit 24 may use obtained training data for training for recognizing estimated noise information.

Furthermore, the training data selection unit may select data for training among training data obtained by the learning data acquisition unit 23 or training data pre-processed by the preprocessor. The selected training data may be provided to the model training unit 24. For example, the training data selection unit may select only data for a syllable, included in a specific region, as training data by detecting the specific region in the feature values of an operating state obtained by the voice output device 10.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

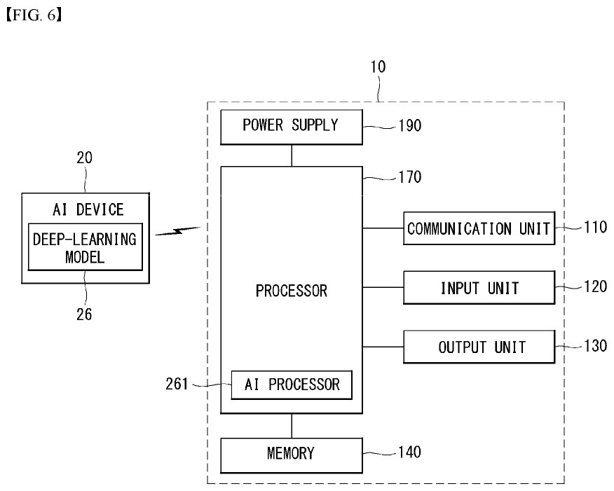

FIG. 6 is an exemplary block diagram of a voice recognizing apparatus according to an embodiment of the present invention.

An embodiment of the present invention may include computer-readable, and computer-executable instructions which may be included in the voice recognizing device 10. Although FIG. 6 illustrates a plurality of components included in the voice recognizing device 10, it should be noted that the voice recognizing device 10 may include other various components not illustrated in FIG. 6.

A plurality of voice recognizing devices may apply to a single voice recognizing device. In such a multi-device system, the voice recognizing device may include different components for performing various aspects of speech recognition processing. The voice recognizing device 10 of FIG. 6 is merely an example, and the voice recognizing device 10 may be implemented as a component of a larger device or system.

An embodiment of the present invention may be applicable to a plurality of different devices and computing systems, e.g., general-purpose computing systems, server-client computing systems, telephone computing systems, laptop computers, portable terminals, portable digital assistants (PDAs), or tablet computers. The voice recognizing device 10 may be applicable as a component of other devices or systems with speech recognition functionality, such as automated teller machines (ATMs), kiosks, global positioning systems (GPSs), home appliances, such as refrigerators, ovens, or washers, vehicles, or ebook readers.

As shown in FIG. 6, the voice recognizing device 10 may include a communication unit 110, an input unit 120, an output unit 130, a memory 140, a power supply unit 190, and/or a processor 170. Some components of the voice recognizing device 10 may be individual components, and one or more of such components may be included in a single device.

The voice recognizing device 10 may include an address/data bus (not shown) for transferring data between the components of the voice recognizing device 10. Each component of the voice recognizing device 10 may be connected directly to the other components via the bus (not shown). Each component of the voice recognizing device 10 may be directly connected with the processor 170.

The communication unit 110 may include a wireless communication device, such as of a radio frequency (RF), infrared (IR), Bluetooth, or wireless local area network (WLAN) (e.g., wireless-fidelity (Wi-Fi)) network or a wireless device of a wireless network, such as a 5G network, long term evolution (LTE), WiMAN, or 3G network.

The input unit 120 may include a microphone, a touch input unit, a keyboard, a mouse, a stylus, or other input units.

The output unit 130 may output information (e.g., voice or speech) processed by the voice recognizing device 10 or other devices. The output unit 130 may include a speaker, a headphone, or other adequate components for propagating voice. As another example, the output unit 130 may include an audio output unit. The output unit 130 may include a display (e.g., a visual display or tactile display), an audio speaker, a headphone, a printer, or other output units. The output unit 130 may be integrated with the voice recognizing device or may be separated from the voice recognizing device.

The input unit 120 and/or the output unit 130 may include interfaces for connection to external peripheral devices, such as universal serial bus (USB), FireWire, Thunderbolt, or other connectivity protocols. The input unit 120 and/or the output unit 130 may include network connections, such as Ethernet ports or modems. The voice recognizing device 10 may access a distributed computing environment or Internet via the input unit 120 and/or the output unit 130. The voice recognizing device 10 may connect to detachable or external memories (e.g., removable memory cards, memory key drives, or network storage) via the input unit 120 or the output unit 130.

The memory 140 may store data and instructions. The memory 140 may include magnetic storage, optical storage, or solid-state storage. The memory 140 may include a volatile RAM, a non-volatile ROM, or other various types of memory.

The voice recognizing device 10 may include the processor 170. The processor 170 may connect to the bus (not shown), the input unit 120, the output unit 130, and/or other components of the voice recognizing device 10. The processor 170 may correspond to a central processing unit (CPU) for processing data and a memory for storing instructions readable by data processing computers, data, and instructions.

Computer instructions to be processed by the processor 170 for operating the voice recognizing device 10 and various components may be executed by the processor 170 and be stored in the memory 140, an external device, or a memory or storage included in the processor 170 which is described below. Alternatively, all or some of the executable instructions may be embedded in software, hardware, or firmware. An embodiment of the present invention may be implemented in various combinations of, e.g., software, firmware, and/or hardware.

Specifically, the processor 170 may process textual data into audio waveforms including voice or process audio waveforms into textual data. The textual data may be generated by an internal component of the voice recognizing device 10. Or, the textual data may be received from the input unit, e.g., a keyboard, or be transmitted to the voice recognizing device 10 via a network connection. Text may be in the form of a sentence including words, numbers, and/or punctuation, to be converted into a speech. Input text may include a special annotation for processing by the processor 170, and the special annotation may indicate how particular text is to be pronounced. Textual data may be processed in real-time or may be stored and processed later.

Although not shown in FIG. 6, the processor 170 may include a front end, a speech synthesis engine, and a text-to-speech (TTS) storage unit. The front end may convert input textual data into a symbolic linguistic representation for processing by the speech synthesis engine. The speech synthesis engine may compare annotated phonetic units models with information stored in the TTS storage unit, thereby converting the input text into voice. The front end and the speech synthesis engine may include an embedded internal processor or memory or may take advantage of the processor 170 and memory 140 included in the voice recognizing device 10. Instructions for operating the front end and the speech synthesis engine may be included in the processor 170, the memory 140 of the voice recognizing device 10, or an external device.

The text input to the processor 170 may be transmitted to the front end for processing. The front end may include a module(s) for performing text normalization, linguistic analysis, and linguistic prosody generation.

During text normalization, the front end processes the text input, generate standard text, and converts the numbers, abbreviations, and symbols into those as written.

During linguistic analysis, the front end may analyze the language of the normalized text, thereby generating a series of phonetic units corresponding to the input text. Such process may be called ‘phonetic transcription.’

Phonetic units include a symbolic representation of sound units which are finally combined and are output as a speech by the voice recognizing device 10. Various sounds may be used to split text for speech synthesis.

The processor 170 may process voice based on phonemes (individual sounds), half-phonemes, di-phones (each of which may mean the latter half of one phoneme combined with a half of its adjacent phoneme, bi-phones (two consecutive phonemes), syllables, words, phrases, sentences, or other units. Each word may be mapped to one or more phonetic units. Such mapping may be performed based on a language dictionary stored in the voice recognizing device 10.

The linguistic analysis performed by the front end may include a process for identifying different syntactic components, such as prefixes, suffixes, phrases, punctuations, or syntactic boundaries. Such syntactic components may be used for the processor 170 to generate a natural audio waveform. The language dictionary may include letter-to-sound rules and other tools which may be used to pronounce prior non-identified words or combinations of letters producible by the processor 170. Generally, as the language dictionary contains more information, higher-quality voice output may be ensured.

Based on the linguistic analysis, the front end may perform linguistic prosody generation annotated with prosodic characteristics which indicate how the final sound units in the phonetic units are to be pronounced in the final output speech.

The prosodic characteristics may also be referred to as acoustic features. While performing the operation, the front end may be integrated with the processor 170 considering any prosodic annotations accompanied by the text input. Such acoustic features may include pitch, energy, and duration. Application of acoustic features may be based on prosodic models available to the processor 170.

Such prosodic models represent how phonetic units are to be pronounced in a particular context. For example, the prosodic models may consider, e.g., a phoneme's position in a syllable, a syllable's position in a word, a word's position in a sentence or phrase, or neighboring phonetic units. As for the language dictionary, more prosodic model information may ensure higher-quality voice output.

The output of the front end may include a series of phonetic units annotated with prosodic characteristics. The output of the front end may be referred to as a symbolic linguistic representation. The symbolic linguistic representation may be transmitted to the speech synthesis engine.

The speech synthesis engine performs conversion of the speech into an audio waveform to thereby be output to the user. The speech synthesis engine may be configured to convert the input text into a high-quality, more natural speech in an efficient manner. Such high-quality speech may be configured to be pronounced as close to the human speaker's speech as possible.

The speech synthesis engine may perform speech synthesis based on at least one or more other methods.

A unit selection engine contrasts a recorded speech database with the symbolic linguistic representation generated by the front end. The unit selection engine matches the symbolic linguistic representation with phonetic audio units of the speech database. To form a speech output, matching units are selected, and the selected matching units may be connected together. Each unit may include not only an audio waveform corresponding to a phonetic unit, such as a short .wav file of a particular sound, but also other pieces of information, such as the phonetic unit's position in a word, sentence, or phrase, or a neighboring phonetic unit, along with a description of various acoustic features related to .wav files (e.g., pitch or energy).

The unit selection engine may match the input text based on all information in the unit database to generate a natural waveform. The unit database may include multiple example phonetic units, which provide different options to the voice recognizing device 10, to connect units to a speech. One advantage of unit selection is to be able to generate a natural speech output depending on the size of the database. As the unit database enlarges, the voice recognizing device 10 may produce a more natural speech.

In addition to the above-described unit selection synthesis, speech synthesis may be performed by parameter synthesis. In parameter synthesis, synthetic parameters, such as frequency, volume, or noise may be transformed by a parameter synthesis engine, digital signal processor, or other audio generators so as to generate an artificial speech waveform.

Parameter synthesis may match the symbolic linguistic representation to desired output speech parameters based on acoustic models and various statistical schemes. Parameter synthesis enables speech processing in a quick and accurate way even without a high-volume database related to unit selection. Unit selection synthesis and parameter synthesis may be performed individually or in combination, thereby generating a speech audio output.

Parameter speech synthesis may be carried out as follows. The processor 170 may include an acoustic model which may convert the symbolic linguistic representation into a synthetic acoustic waveform of text input based on audio signal manipulation. The acoustic model may include rules which may be used by a parameter synthesis engine to allocate specific audio waveform parameters to input phonetic units and/or prosodic annotations. The rules may be used to calculate a score indicating the probability of a particular audio output parameter (e.g., frequency or volume) to correspond to a portion of the input symbolic linguistic representation from the front end.

The parameter synthesis engine may adopt a plurality of techniques to match the to-be-synthesized speech to the input phonetic units and/or prosodic annotations. An available common technique is hidden Markov model (HMM). HMM may be used to determine the probability of the audio output to match the text input. HMM may be used to convert parameters of acoustic space and language into parameters for use by a vocoder (e.g., a digital voice encoder) so as to artificially synthesize a desired speech.

The voice recognizing device 10 may include a phonetic unit database for use in unit selection. The phonetic unit database may be stored in the memory 140 or other storage component. The phonetic unit database may include recorded speech utterances. The speech utterances may be text corresponding to what have been spoken. The phonetic unit database may include recorded speeches (e.g., audio waveforms, feature vectors, or other formats) occupying a significant storage space in the voice recognizing device 10. The unit samples of the phonetic unit database may be classified in various manners, such as in phonetic units (e.g., phonemes, di-phones, or words), linguistic prosody labels, or acoustic feature sequences, or speakers' identity. Sample utterance may be used to generate mathematical models corresponding to desired audio outputs for particular phonetic units.

The speech synthesis engine may select, form the phonetic unit database, a unit which is closest to, or matches, the input text (including all of the phonetic units and prosodic symbolic annotations) upon matching the symbolized linguistic representation. Generally, the larger the phonetic unit database is, the more unit samples may be selected, so that an accurate speech output may be obtained.

The processor 170 may transfer audio waveforms including speech output to the output unit 130 to be output to the user. The processor 170 may store, in the memory 140. speech-containing audio waveforms, in a plurality of different formats, e.g., a series of feature vectors, uncompressed audio data, or compressed audio data. For example, the processor 170 may encode and/or compress the speech output using an encoder/decoder before transmitting the speech output. The encoder/decoder may encode and decode audio data, such as feature vectors or digitalized audio data. The encoder/decoder may be positioned in separate components or their functions may be performed by the processor 170.

The memory 140 may store other pieces of information for speech recognition. The contents in the memory 140 may be prepared for use of common speech recognition and TTS and may be customized to include sounds or words which are likely to be used by a particular application. For example, for TTS processing by a GPS device, TTS storage may include customized speeches specified for positioning and navigation.

The memory 140 may be customized by the user based on personalized, desired speech output. For example, the user may prefer output voices of a specific gender, intonation, speed, or emotion (e.g., happy voice). The speech synthesis engine may include a specialized database or model to describe such user preferences.

The voice recognizing device 10 may be configured to perform TTS processing in multiple languages. For each language, the processor 170 may include data, instructions, and/or components specifically configured to synthesize speeches in the desired language.

For better performance, the processor 170 may modify or update the contents in the memory 140 based on feedback for TTS processing results. Thus, the processor 170 may enhance speech recognition more than a training corpus may do.

Advances in the processing performance of the voice recognizing device 10 enable the speech output to reflect the emotional property of the input text. Although the input text lacks an emotional property, the voice recognizing device 10 may output a speech reflecting the intent (emotional information) of the user who has created the input text.

In practice, upon building up a model which is to be integrated with the TTS module for TTS processing, the TTS system may merge the above-mentioned components with other components. As an example, the voice recognizing device 10 may include blocks for setting speakers.

A speaker setting unit may set speakers per character which appears on the script. The speaker setting unit may be integrated with the processor 170 or be integrated as part of the front end or speech synthesis engine. The speaker setting unit enables text corresponding to a plurality of characters to be synthesized in the voice of the set speakers based on metadata corresponding to speaker profiles.

According to an embodiment of the present invention, the metadata may adopt the markup language, preferably the speech synthesis markup language (SSML).

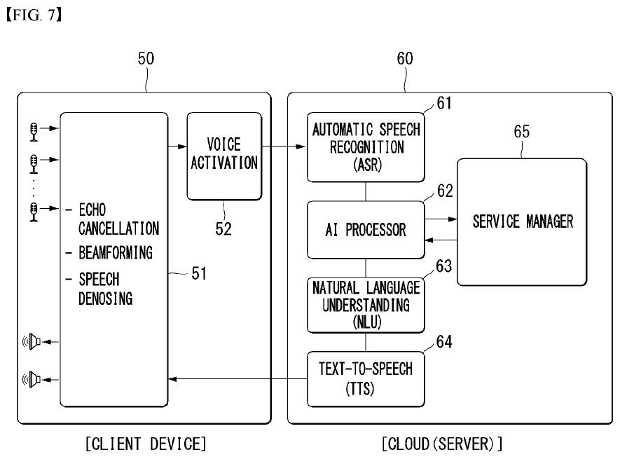

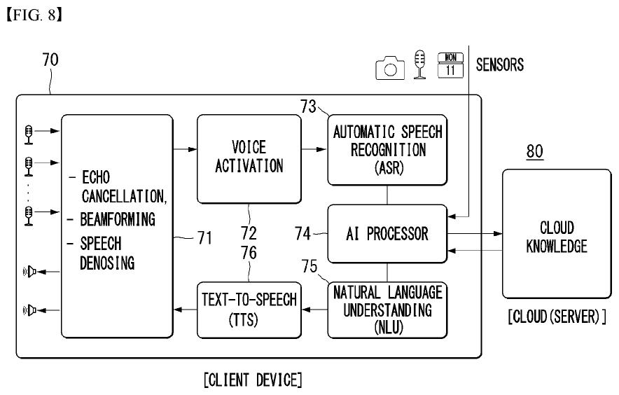

Described below with reference to FIGS. 7 and 8 is speech processing (speech recognition and speech output (TTS)) performed in a device environment and/or cloud environment or server environment. Referring to FIGS. 7 and 8, device environments 50 and 70 may be referred to as client devices, and cloud environments 60 and 80 may be referred to as servers. FIG. 7 illustrates an example in which, although speech input is performed by the device 50, the overall speech processing, e.g., processing input speech to thereby synthesize an output speech, is carried out in the cloud environment 60. In contrast, FIG. 8 illustrates an example of on-device processing by which the entire speech processing for processing input speech and synthesizing an output speech is performed by the device 70.

FIG. 7 is a block diagram schematically illustrating a voice recognizing device in a speech recognition system environment according to an embodiment of the present invention.

Speech event processing in an end-to-end speech UI environment requires various components. A sequence for processing a speech event includes gathering speech signals (signal acquisition and playback), speech pre-processing, voice activation, speech recognition, natural language processing, and speech synthesis which is the device's final step of responding to the user.

The client device 50 may include an input module. The input module my receive user input from the user. For example, the input module may receive user input from an external device (e.g., a keyboard or headset) connected thereto. For example, the input module may include a touchscreen. As an example, the input module may include hardware keys positioned in the user terminal.

According to an embodiment, the input module may include at least one microphone capable of receiving the user's utterances as voice signals. The input module may include a speech input system and receive user utterances as voice signals through the speech input system. The at least one microphone may generate input signals, thereby determining digital input signals for the user's utterances. According to an embodiment, a plurality of microphones may be implemented as an array. The array may be configured in a geometrical pattern, e.g., a linear geometrical shape, a circular geometrical shape, or other various shapes. For example, four sensors may be arrayed in a circular shape around a predetermined point and be spaced apart from each other at 90 degrees to receive sounds from four directions. In some implementations, the microphones may include an array of sensors in different spaces for data communication, and an array of networked sensors may be included. The microphones may include omni-directional microphones or directional microphones (e.g., shotgun microphones).

The client device 50 may include a pre-processing module 51 capable of pre-processing user input (voice signals) received through the input module (e.g., microphones).

The pre-processing module 51 may have adaptive echo canceller (AEC) functionality, thereby removing echoes from the user input (voice signals) received through the microphones. The pre-processing module 51 may have noise suppression (NS) functionality, thereby removing background noise from the user input. The pre-processing module 51 may have end-point detect (EPD) functionality, thereby detecting the end point of the user's speech and hence discovering the portion where the user's voice is present. The pre-processing module 51 may have automatic gain control (AGC) functionality, thereby adjusting the volume of the user input to be suited for recognizing and processing the user input.

The client device 50 may include a voice activation module 52. The voice activation module 52 may recognize a wake-up command to recognize the user's invocation (e.g., a wake-up word). The voice activation module 52 may detect predetermined keywords (e.g., ‘Hi,’ or ‘LG’) from the user input which has undergone the pre-processing. The voice activation module 52 may stay idle and perform the functionality of always-on keyword detection.

The client device 50 may transmit the user voice input to the cloud server. Although core components of user speech processing, e.g., automatic speech recognition (ASR), and natural language understanding (NLU), are typically performed by cloud due to, e.g., limited computing, storage, and power, embodiments of the present invention are not necessarily limited thereto, and such operations may also be performed by the client device 50 according to an embodiment.

The cloud may include a cloud device 60 for processing the user input received from the client. The cloud device 60 may be present in the form of a server.

The cloud device 60 may include an automatic speech recognition (ASR) module 61, an artificial intelligence agent 62, a natural language understanding (NLU) module 63, a text-to-speech (TTS) module 64, and a service manager 65.

The ASR module 61 may convert the user voice input received from the client device 50 into textual data.

The ASR module 61 includes a front-end speech pre-processor. The front-end speech processor extracts representative features from the speech input. For example, the front-end speech processor performs the Fourier transform on the speech input to thereby extracts a spectrum feature, which specifies the speech input, as a representative multi-dimensional vector sequence. The ASR module 61 may include one or more speech recognition models (e.g., acoustic models and/or linguistic models) and implement one or more speech recognition engines. Example speech recognition models include hidden Markov models, Gaussian-mixture models, deep neutral network models, n-gram linguistic models, and other statistical models. Example speech recognition engines include dynamic time distortion-based engines and weighted finite state transducer (WFST)-based engines. One or more speech recognition models and one or more speech recognition engines may be used to process the representative features extracted by the front-end speech processor so as to generate intervening recognition results (e.g., phonemes, phoneme strings, and hyponyms), and ultimately text recognition results (e.g., words, word strings, or sequences of tokens).

If the ASR module 61 generates a recognition result including a text string (e.g., words, a sequence of words, or a sequence of tokens), the recognition result is transferred to the NLU module 63 for intent inference. In some examples, the ASR module 61 generate multiple candidate text representations of the speech input. Each candidate text representation is a sequence of words or tokens corresponding to the speech input.

The NLU module 63 may perform syntactic analysis or semantic analysis to grasp the user's intent. The syntactic analysis may divide the user input into syntactic units (e.g., words, phrases, or morphemes) and figure out what syntactic components the syntactic units have. The semantic analysis may be performed using, e.g., semantic matching, rule matching, or formula matching. Thus, the NLU module 63 may obtain a domain, intent, or parameters necessary to represent the intent for the user input.

The NLU module 63 may determine the user's intent and parameters based on the matching rule which has been divided into the domain, intent, and parameters necessary to grasp the intent. For example, one domain (e.g., an alarm) may include a plurality of intents (e.g., set or release an alarm), and one intent may include a plurality of parameters (e.g., time, repetition count, or alarm sound). The plurality of rules may include, e.g., one or more essential element parameters. The matching rule may be stored in an natural language understanding (NLU) database (DB).

The NLU module 63 may grasp the meaning of a word extracted from the user input using linguistic features (e.g., syntactic elements) such as morphemes or phrases, match the grasped meaning of the word to the domain and intent, and determine the user's intent.

For example, the NLU module 63 may calculate how many words extracted from the user input are included in each domain and intent to thereby determine the user's intent. According to an embodiment, the NLU module 63 may determine the parameters of the user input using the word which is a basis for grasping the intent.

According to an embodiment, the NLU module 63 may determine the user's intent using the NLU DB storing the linguistic features for grasping the intent of the user input.

According to an embodiment, the NLU module 63 may determine the user's intent based on a personal language model (PLM). For example, the NLU module 63 may determine the user's intent using personal information (e.g., a contacts list, music list, schedule information, or social media information).

The personal language model may be stored in, e.g., the NLU DB. According to an embodiment, the ASR module 61, but not the NLU module 63 alone, may recognize the user's voice by referring to the personal language model stored in the NLU DB.

The NLU module 63 may further include a natural language generation module (not shown). The natural language generation module may convert designated information into text-type information. The text-type information may be in the form of a natural language utterance. The designated information may be, e.g., information about an additional input, information indicating that the operation corresponding to the user input is complete, or information indicating the user's additional input. The text-type information may be transmitted to the client device to be displayed on the display or may be transmitted to the TTS module to be converted into a speech.

The TTS module 64 may convert text-type information into speech-type information. The TTS module 63 may receive the text-type information from the natural language generation module of the NLG module 63, convert the text-type information into speech-type information, and send the speech-type information to the client device 50. The client device 50 may output the speech-type information via a speaker.

The speech synthesis module 64 synthesize a speech output based on the provided text. For example, the result generated by the ASR module 61 is in the form of a text string. The speech synthesis module 64 converts the text string into an audible speech output. The speech synthesis module 64 uses any adequate speech synthesis scheme to generate text into speech output, including, but not limited to, concatenative synthesis, unit selection synthesis, di-phone synthesis, domain-specific synthesis, formant synthesis, articulatory synthesis, hidden Markov model (HMM)-based synthesis, and sinewave synthesis.

In some examples, the speech synthesis module 64 is configured to synthesize individual words based on phoneme strings corresponding to words. For example, the phoneme strings are related to the words in the generated text string. The phoneme strings are stored in metadata related to the words. The speech synthesis module 64 is configured to directly process the phoneme strings in the metadata to synthesize words in the form of a speech.

Since cloud environments have more processing capability and resources than client devices, synthesis by clouds may actually present higher-quality of speech output that synthesis by clients. However, the present invention is not limited thereto, but speech synthesis may be performed by the client device (refer to FIG. 8).

According to an embodiment of the present invention, the cloud environment may further include an artificial intelligence (AI) processor (also referred to as an AI agent) 62. The AI processor 62 may be designed to perform at least some of the above-described functions of the ASR module 61, the NLU module 63, and/or the TTS module 64. The AI processor 62 may contribute to allowing the ASR module 61, the NLU module 63, and/or the TTS module 64 to perform their respective independent functions.

The AI processor 62 may perform the above-described functions via deep learning. Various research efforts (as to, e.g., how to create better representation schemes and, if created, how to learn such schemes) are underway to deep learning to represent some data in a computer-understandable form (e.g., representing image pixel information as column vectors) and apply the representation to learning and, thus, various deep learning schemes, such as deep neural networks (DNN), convolutional deep neural networks (CNN), recurrent Boltzmann machine (RNN), restricted Boltzmann machine (RBM), deep belief networks (DBN), and deep Q-network, are applicable to computer vision, speech recognition, natural language processing, voice/signal processing, or other various industry sectors.

All major commercial speech recognition systems, as of today, (e.g., MS Cortana, Skype translator, Google Now, Apple Siri, etc.) are based on deep learning.

The AI processor 62 may, among others, adopt the deep artificial neural network structure to carry out machine translation, emotion analysis, information retrieval, or other various types of natural language processing.

The cloud environment may include the service manager 65 which may gather various pieces of personal information and support the functions of the AI processor 62. The personal information obtained by the service manager may include at least one piece of data (e.g., calendar applications, message services, music applications) the client device 50 uses via the cloud environment, at least one piece of sensing data (e.g., data obtained by cameras, microphones, temperature, humidity, or gyro sensors, C-V2X, pulses, ambient light, or iris scans) gathered by the client device 50 and/or the cloud 60, and off-device data which are not directly related to the client device 50. For example, the personal information may include maps, SMS, news, music, stock, weather, or Wikipedia information.

Although the AI processor 62 is shown in a separate block distinguished from the ASR module 61, the NLU module 63, and TTS module 64 for illustration purposes, the AI processor 62 may perform all or at least some of the functions of each module 61, 62, and 64.

The AI processor 62 may perform at least some of the functions of the AI processors 21 and 261 described above in connection with FIGS. 5 and 6.

FIG. 8 is a block diagram schematically illustrating a voice recognizing device in a speech recognition system environment according to an embodiment of the present invention.

The client device 70 and cloud environment 80 of FIG. 8 may correspond to the client device 50 and cloud environment 60 of FIG. 7 except for differences in some components and functions. The description taken in conjunction with FIG. 7 may thus apply to specific functions of the corresponding blocks.

Referring to FIG. 8, the client device 70 may include a pre-processing module 71, a voice activation module 72, an ASR module 73, an AI processor 74, an NLU module 75, and a TTS module 76. The client device 70 may include an input module (at least one microphone) and at least one output module.

The cloud environment 80 may include a cloud knowledge storing personal information in the form of knowledge.

The description taken in conjunction with FIG. 7 may apply to the functions of each module of FIG. 8. However, as the ASR module 73, the NLU module 75, and the TTS module 76 are included in the client device 70, there is no need for communicating with the cloud for speech processing, e.g., speech recognition and speech synthesis, and immediate, real-time speech processing may thus be possible.

Each module shown in FIGS. 7 and 8 is merely an example for describing speech processing, and more or less modules than those shown in FIGS. 7 and 8 may be included. It should also be noted that two or more of the modules may be combined or different modules or different arrays of modules may be included. Various modules shown in FIGS. 7 and 8 may be implemented in one or more signal processing processors, application-specific integrated circuits (ASICs), hardware, software instructions executed by one or more processors, firmware, or combinations thereof.

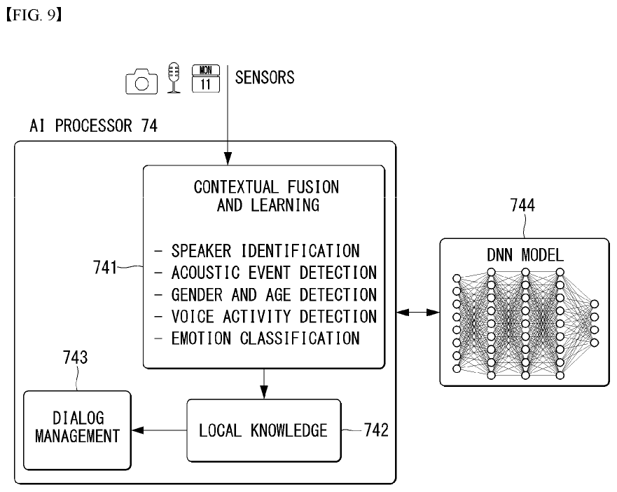

FIG. 9 is a block diagram schematically illustrating an AI processor capable of implementing speech recognition according to an embodiment of the present invention.

Referring to FIG. 9, the AI processor 74 may support interactive operations with the user in addition to performing the ASR operation, NLU operation, and TTS operation in the speech recognition process described above in connection with FIGS. 7 and 8. The AI processor 74 may contribute to allowing the NLU module 63 of FIG. 7 to perform the operations of clarifying the information contained in the text representations received from the ASR module 61, adding, or making extra definitions using context information.

The context information may include the preference of the user of the client device, hardware and/or software statuses of the client device, various pieces of sensor information gathered before, while, or immediately after user input, and prior interactive operations (e.g., dialogs) between the AI processor and the user. In this disclosure, the context information may be features which are dynamic and vary depending on times, positions, dialogs, and other elements.

The AI processor 74 may further include a context fusion learning module 741, a local knowledge 742, and a dialog management 743.

The context fusion and learning module 741 may learn the user's intent based on at least one piece of data. The at least one piece of data may include at least one piece of sensing data obtained by the client device or cloud environment. The at least one piece of data may include data resulting from speaker identification, acoustic event detection, speaker personal information (gender and age) detection, voice activity detection (VAD), and emotion classification.

The speaker identification may mean identifying a speaker from a dialog group registered by speeches. The speaker identification may include identifying an already-registered speaker or registering new speakers. The acoustic event detection, beyond speech recognition technology, may recognize a sound itself, thereby recognizing the type of the sound and the place from which the sound originates. The VAD is speech processing technology of detecting the presence or absence of a human speech in an audio signal which may include music, noise, or other sounds. As an example, the AI processor 74 may identify whether a speech is present in the input audio signal. As an example, the AI processor 74 may distinguish speech data from non-speech data based on a deep neural networks (DNN) model. The AI processor 74 may perform emotion classification on the speech data based on the DNN model. By the emotion classification, the speech data may be classified into anger, boredom, fear, happiness, and sadness.

The context fusion and learning module 741 may include a DNN model to perform the above-described operations and may identify the intent of the user input based on sensing information gathered by the client device or cloud environment and the DNN model.

The at least one piece of data is merely an example and any data which may be referenced to identify the user's intent in speech processing may be included. The at least one piece of data may be obtained by the above-described DNN model.

The AI processor 74 may include a local knowledge 742. The local knowledge 742 may include user data. The user data may include, e.g., the user's preference, address, default language, and contacts list. As an example, the AI processor 74 may make an additional definition to the user's intent by supplementing the information contained in the user's speech information based on the user's specific information. For example, in response to the user's request “Please invite my friends to my birthday party,” the AI processor 74 may use the local knowledge 742 without the need for requesting the user to provide more detailed information to determine who the “friends” are and when and where the “birthday party” is held.

The AI processor 74 may further include the dialog management 743. The AI processor 74 may provide a dialog interface for a voice talk with the user. The dialog interface may mean the process of outputting a response to the user's speech input via a display or speaker. The final results output via the dialog interface may be based on the above-described ASR operation, NLU operation, and TTS operation.

I. Speech Recognition Method

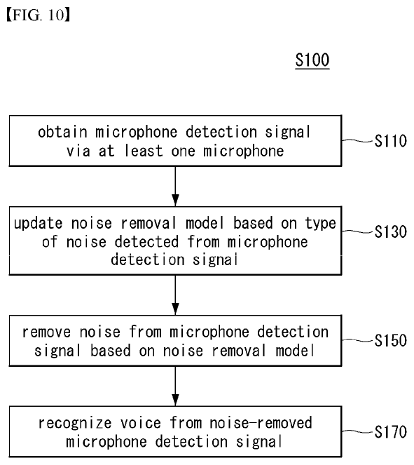

FIG. 10 is a flowchart illustrating a voice recognizing method according to an embodiment of the present invention.

Referring to FIG. 10, a voice recognizing device may perform the intelligent voice recognizing method S100 of FIG. 10 which is described below in detail.

First, a processor (e.g., the processor 170, the AI processor 21, or the AI processor 261) of the voice recognizing device 10 may obtain a microphone detection signal via at least one microphone (e.g., the input unit 120) (S110).

Subsequently, the processor may update a noise removal model based on the type of noise detected from the microphone detection signal (S1300.

Here, the processor may detect noise from the microphone detection signal. Then, the processor may determine the type of the detected noise. Thereafter, the processor may search a pre-stored database for the type of the detected noise. Here, the database may store data related to a plurality of noise types and per-noise type optimal parameters. Then, the processor may obtain parameters corresponding to the searched-for noise type. Next, the processor may update the noise removal model based on the obtained parameters.

Here, the noise removal model may be an adaptive filter. For example, the adaptive filter is a filter which varies the filter parameters (coefficients) based on results of analysis of the noise-removed microphone detection signal to remove noise from the microphone detection signal.

Here, the obtained parameters may include parameters in a time interval during which the waveform of noise-removed microphone detection signal converges to a particular value within the entire duration during which noise is removed from the microphone detection signal from which a corresponding type of noise is detected, and the parameters at this time may be defined as optimal parameters.

The processor may update the parameters of the adaptive filter with the parameters obtained via the database.

Subsequently, the processor may remove noise from the microphone detection signal based on the updated noise removal model (S150).

Last, the processor may recognize the speech from the noise-removed microphone detection signal (S170).

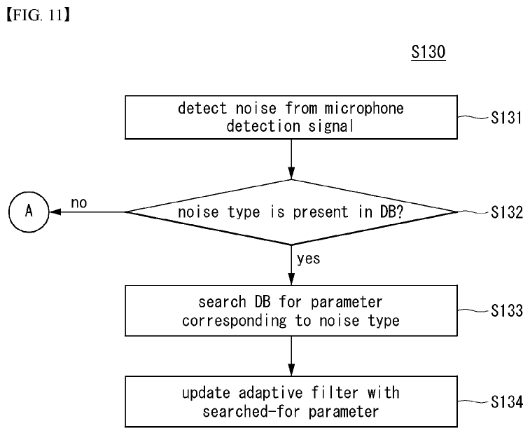

FIG. 11 is a flowchart illustrating a specific example of the updating (S130) of FIG. 10.

Referring to FIG. 11, first, the processor may detect noise from a microphone detection signal (S131).

Then, the processor may determine the type of the noise detected from the microphone detection signal and determine whether the determined noise type is present in a database (DB) (S132).

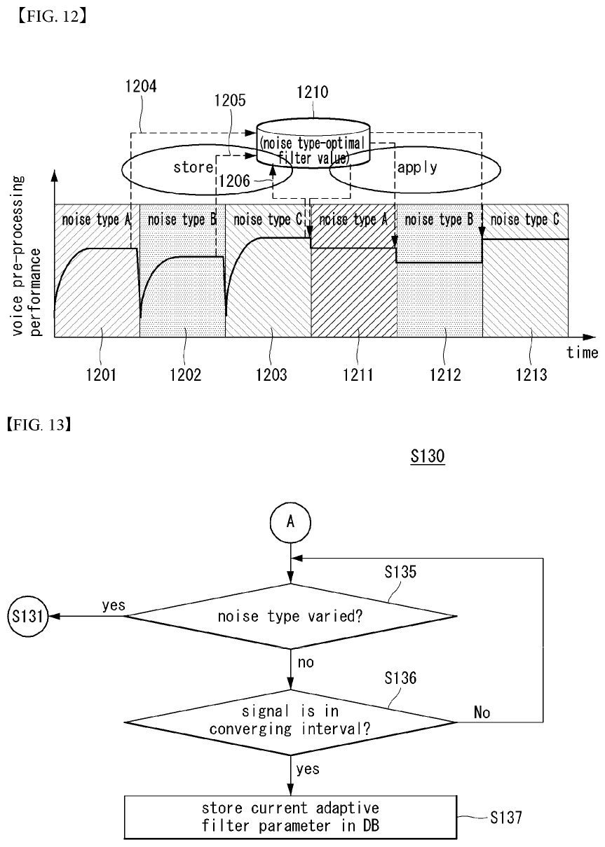

When the determined noise type is determined to be not present in the DB, the processor may proceed with procedure A which is described below in greater detail with reference to FIG. 13.

When the determined noise type is determined to be present in the DB, the processor may search the database for the parameters corresponding to the noise type (S133).

Then, the processor may update the parameters (coefficients) of the adaptive filter with the searched-for parameters (S134).

FIG. 12 is a view illustrating an example process of updating a noise removal model.

Referring to FIG. 12, a processor may monitor speech pre-processing performance (noise removal performance or the magnitude of the noise-removed microphone detection signal alone) for the microphone detection signal over time.

Here, the processor may detect a noise type (noise type A) detected from the microphone detection signal in a first interval 1201, a noise type (noise type B) detected from the microphone detection signal in a second interval 1202, and a noise type (noise type C) detected from the microphone detection signal in a third interval 1203.

The processor may store a first parameter 1204 of an adaptive filter (noise removal model) in an interval, during which the speech pre-processing performance converges, of the first interval 1201 in a database (noise type-optimal filter (value)) 1210. The processor may store a second parameter 1205 of the adaptive filter (noise removal model) in an interval, during which the speech pre-processing performance converges, of the second interval 1202 in the database (noise type-optimal filter (value)) 1210. The processor may store a third parameter 1206 of the adaptive filter (noise removal model) in an interval, during which the speech pre-processing performance converges, of the third interval 1203 in the database (noise type-optimal filter (value)) 1210.

After storing the first parameter, the second parameter, and the third parameter, the processor may determine that the noise type of the microphone detection signal in a fourth interval 1211 is the same noise type, i.e., noise type A, as the noise type detected in the first interval 1201. After determining that the noise type in the fourth interval 1211 is currently noise type A, the processor may retrieve and obtain, from the database 1210, the first parameter of the adaptive filter, which has been used in the first interval 1211, for the parameter of the adaptive filter to be applied to the microphone detection signal in the fourth interval 1211 and may remove noise from the microphone detection signal.

After storing the first parameter, the second parameter, and the third parameter, the processor may determine that the noise type of the microphone detection signal in a fifth interval 1212 is the same noise type, i.e., noise type B, as the noise type detected in the second interval 1202. After determining that the noise type in the fifth interval 1212 is currently noise type B, the processor may retrieve and obtain, from the database 1210, the second parameter of the adaptive filter, which has been used in the second interval 1212, for the parameter of the adaptive filter to be applied to the microphone detection signal in the fifth interval 1212 and may remove noise from the microphone detection signal.

After storing the first parameter, the second parameter, and the third parameter, the processor may determine that the noise type of the microphone detection signal in a sixth interval 1213 is the same noise type, i.e., noise type C, as the noise type detected in the third interval 1203. After determining that the noise type in the sixth interval 1213 is currently noise type C, the processor may retrieve and obtain, from the database 1210, the third parameter of the adaptive filter, which has been used in the third interval 1213, for the parameter of the adaptive filter to be applied to the microphone detection signal in the sixth interval 1213 and may remove noise from the microphone detection signal.

FIG. 13 is a flowchart illustrating another specific example of the updating (S130) of FIG. 10.

Referring to FIG. 13, when the currently detected noise type is determined to be not present in the database as a result of determination in step S132 of FIG. 11, the processor may determine whether the noise type is varied (S135).

When the noise type is determined to be varied, the processor may perform step S131 of FIG. 11.

When the noise type is determined to remain unchanged, the processor may determine whether the microphone detection signal from which noise is being removed is in a converging interval (S136).

Unless the noise type is determined to be in the converging interval, the processor may again perform step S135.

When the noise type is determined to be in the converging interval, the processor may store the current parameter of the adaptive filter in the database (DB) (S137).

The processor may reapply the currently stored adaptive filter parameter when the same noise type is again detected later.

### SUMMARY OF EMBODIMENTS

### Embodiment 1

An intelligent voice recognizing method of a voice comprises: recognizing device obtaining a microphone detection signal through at least one microphone; removing noise from the microphone detection signal based on a noise removal model; recognizing a voice from the noise-removed microphone detection signal, wherein removing the noise includes updating the noise removal model based on a type of noise detected from the microphone detection signal.

### Embodiment 2

In embodiment 1, the noise removal model includes an adaptive filter, and updating the noise removal model includes updating a parameter of the adaptive filter.

### Embodiment 3

In embodiment 2, updating the noise removal model includes searching a database for a parameter corresponding to the detected noise type, the database storing a plurality of noise types and a plurality of parameters per noise type and updating the parameter of the adaptive filter based on the searched-for parameter.

### Embodiment 4

In embodiment 3, the plurality of parameters per noise type include the parameter of the adaptive filter in a convergence interval, during which a magnitude of the microphone detection signal converges to a particular value, of an entire time during which adaptive noise removal is performed on a microphone detection signal from which a particular type of noise has been detected

### Embodiment 5

An intelligent voice recognizing device comprises: a communication unit; at least one microphone; and a processor obtaining a microphone detection signal through the at least one microphone, remove noise from the microphone detection signal based on a noise removal model, and recognizing a voice from the noise-removed microphone detection signal, wherein the processor updates the noise removal model based on a type of noise detected from the microphone detection signal.

### Embodiment 6

In embodiment 5, the noise removal model includes an adaptive filter, and the processor updates a parameter of the adaptive filter.

### Embodiment 7

In embodiment 6, the processor searches a database for a parameter corresponding to the detected noise type, the database storing a plurality of noise types and a plurality of parameters per noise type and updates the parameter of the adaptive filter based on the searched-for parameter.

### Embodiment 8

In embodiment 7, the plurality of parameters per noise type include the parameter of the adaptive filter in a convergence interval, during which a magnitude of the microphone detection signal converges to a particular value, of an entire time during which adaptive noise removal is performed on a microphone detection signal from which a particular type of noise has been detected

### Embodiment 9

There is provided a non-transitory computer-readable medium storing a computer-executable component configured to be executed by one or more processors of a computing device, the computer-executable component comprising obtaining a microphone detection signal, removing noise from the microphone detection signal based on a noise removal model, recognizing a voice from the noise-removed microphone detection signal, and updating the noise removal model based on a type of noise detected from the microphone detection signal.

According to embodiments of the present invention, the intelligent voice recognizing method, apparatus, and intelligent computing device may present the following effects.

The present invention may prevent deterioration of speech recognition performance by reusing the parameters of the adaptive filter in the converging interval in similar environments.

The present invention may previously store the optimal parameter in the converging interval during noise removal and, when a similar noise environment occurs, use the stored optimal parameter in noise removal, thereby minimizing the converging interval of the noise removal.

Effects of the present invention are not limited to the foregoing, and other unmentioned effects would be apparent to one of ordinary skill in the art from the following description.

The above-described invention may be implemented in computer-readable code in program-recorded media. The computer-readable media include all types of recording devices storing data readable by a computer system. Example computer-readable media may include hard disk drives (HDDs), solid state disks (SSDs), silicon disk drives (SDDs), ROMs, RAMs, CD-ROMs, magnetic tapes, floppy disks, and/or optical data storage, and may be implemented in carrier waveforms (e.g., transmissions over the Internet). The foregoing detailed description should not be interpreted not as limiting but as exemplary in all aspects. The scope of the present invention should be defined by reasonable interpretation of the appended claims and all equivalents and changes thereto should fall within the scope of the invention.

What is claimed is:

1. A method of intelligently recognizing a voice by a voice recognizing device, the method comprising:
obtaining a microphone detection signal through at least one microphone;
removing noise from the microphone detection signal based on a noise removal model; and
recognizing a voice from the noise-removed microphone detection signal,
wherein removing the noise includes updating the noise removal model based on a type of noise detected from the microphone detection signal.

2. The method of claim 1,
wherein the noise removal model includes an adaptive filter, and
wherein updating the noise removal model includes updating a parameter of the adaptive filter.

3. The method of claim 2,
wherein updating the noise removal model includes:
searching a database for a parameter corresponding to the detected noise type, the database storing a plurality of noise types and a plurality of parameters per noise type, and
updating the parameter of the adaptive filter based on the searched-for parameter.

4. The method of claim 3, wherein the plurality of parameters per noise type include the parameter of the adaptive filter in a convergence interval, during which a magnitude of the microphone detection signal converges to a particular value, of an entire time during which adaptive noise removal is performed on a microphone detection signal from which a particular type of noise has been detected.

5. A device for recognizing a voice, comprising:
a communication unit;
at least one microphone; and
a processor obtaining a microphone detection signal through the at least one microphone, remove noise from the microphone detection signal based on a noise removal model, and recognizing a voice from the noise-removed microphone detection signal,
wherein the processor updates the noise removal model based on a type of noise detected from the microphone detection signal.

6. The device of claim 5, wherein the noise removal model includes an adaptive filter, and wherein the processor updates a parameter of the adaptive filter.

7. The device of claim 6, wherein the processor searches a database for a parameter corresponding to the detected noise type, the database storing a plurality of noise types, and a plurality of parameters per noise type, and updates the parameter of the adaptive filter based on the searched-for parameter.

8. The device of claim 7, wherein the plurality of parameters per noise type include the parameter of the adaptive filter in a convergence interval, during which a magnitude of the microphone detection signal converges to a particular value, of an entire time during which adaptive noise removal is performed on a microphone detection signal from which a particular type of noise has been detected.

9. A non-transitory computer-readable medium storing a computer-executable component configured to be executed by one or more processors of a computing device, the computer-executable component comprising:
obtaining a microphone detection signal;
removing noise from the microphone detection signal based on a noise removal model;
recognizing a voice from the noise-removed microphone detection signal; and
updating the noise removal model based on a type of noise detected from the microphone detection signal.
